(19) United States
(12) Patent Application Publication
(10) Pub. No.: US 2026/0212528 A1
(43) Pub. Date: Jul. 23, 2026

(54) JOINT BITRATE ADAPTATION AND FEATURE EXTRACTION FOR EDGE-ASSISTED LOCALIZATION OF MOBILE DEVICES

(71) Applicant: TELEFONAKTIEBOLAGET LM ERICSSON (PUBL), STOCKHOLM (SE)

(72) Inventors: José Araújo, Stockholm (SE); Yakov Teplitsky, Cupertino, CA (US); Per-Erik Brodin, Scotts Valley, CA (US); André Mateus, Uppsala (SE); Paula Carbó Cubero, Stockholm (SE)

(21) Appl. No.: 19/142,614

(22) PCT Filed: Dec. 23, 2022
(86) PCT No.: PCT/US2022/053957

§ 371 Date: Jun. 23, 2025

(51) Int. Cl. G06T 7/73; H04N 19/164; H04N 19/172

(52) U.S. Cl. CPC G06T 7/73; H04N 19/164; H04N 19/172

(57) ABSTRACT

Systems and methods are disclosed for joint bitrate adaptation and feature extraction for server-assisted localization of mobile devices. In one embodiment, a method performed by a mobile device comprises obtaining an image of an environment in which the mobile device is located, determining a desired bitrate for compression of the image, and determining whether one or more criteria for transmission of the image at the desired bitrate are satisfied. The method further comprises, if the criteria are not satisfied, performing a feature extraction procedure that detects features in the image and provides feature information comprising information that describes the detected features and information that indicates locations of the features within the image and transmitting the feature information to the associated server. The method further comprises, if any of the criteria are satisfied, compressing the image at the desired bitrate and transmitting the compressed image to the associated server.

### TECHNICAL FIELD

The present disclosure relates to Simultaneous Localization and Mapping (SLAM) for a mobile device and, more specifically, server, or edge, assisted SLAM.

### BACKGROUND

Localization and mapping, which is also known as Simultaneous Localization and Mapping (SLAM), refers to a computer-implemented procedure for constructing or updating a map an unknown environment while simultaneously keeping track of a mobile device's location within the unknown environment. Existing SLAM procedures are oftentimes implemented at the mobile device and are very energy demanding. As such, there is a need for systems and methods that reduce the energy demands of a SLAM procedure on the mobile device.

### SUMMARY

Systems and methods are disclosed for joint bitrate adaptation and feature extraction for server, or edge, assisted localization of mobile devices. In one embodiment, a method performed by a mobile device for server-assisted localization and mapping comprises obtaining an image of an environment in which the mobile device is located from an associated camera and determining a desired bitrate for compression of the image based on one or more network conditions of a wireless network over which the mobile device is to transmit the image to an associated server for server-assisted localization and mapping. The method further comprises determining whether one or more criteria for transmission of the image at the desired bitrate are satisfied, the one or more criteria comprising a criterion that the image is to be transmitted at the desired bitrate if the desired bitrate is greater than a predefined or configured threshold bitrate for server-assisted localization and mapping. The method further comprises, if the one or more criteria are not satisfied, performing a feature extraction procedure that detects one or more features in the image and provides feature information comprising information that describes the one or more features detected in the image and information that indicates locations of the one or more features within the image and transmitting the feature information to the associated server for server-assisted localization and mapping. The method further comprises, if any of the one or more criteria are satisfied, compressing the image at the desired bitrate to provide a compressed image and transmitting the compressed image to the associated server for server-assisted localization and mapping. In this manner, image compression can be performed while also maintaining an acceptable level of performance for the server-assisted localization and mapping.

In one embodiment, the one or more criteria for transmission of the image at the desired bitrate comprises a criterion that the image is to be transmitted at the desired bitrate if the image is a keyframe, even if the desired bitrate is less than the predefined or configured threshold bitrate for server-assisted localization and mapping. In one embodiment, keyframes for the server-assisted localization and mapping are defined as every Nth image where N is an integer value that is greater than 1, defined as images obtained after the mobile device has moved more than a predefined or configured distance, or defined an image for which an overlap between the image and a last keyframe is less than a predefined or configured amount of overlap.

In one embodiment, determining the desired bitrate for compression of the image based on the one or more network conditions of the wireless network is in accordance with a bitrate adaptation scheme that dynamically adapts bitrate according to available network bandwidth.

In one embodiment, the method is repeated for a plurality of images.

Corresponding embodiments of a mobile device are also disclosed. In one embodiment, a mobile device for server-assisted localization and mapping is adapted to obtain an image of an environment in which the mobile device is located from an associated camera and determine a desired bitrate for compression of the image based on one or more network conditions of a wireless network over which the mobile device is to transmit the image to an associated server for server-assisted localization and mapping. The mobile device is further adapted to determine whether one or more criteria for transmission of the image at the desired bitrate are satisfied, the one or more criteria comprising a criterion that the image is to be transmitted at the desired bitrate if the desired bitrate is greater than a predefined or configured threshold bitrate for server-assisted localization and mapping. The mobile device is further adapted to, if the one or more criteria are not satisfied, perform a feature extraction procedure that detects one or more features in the image and provides feature information comprising information that describes the one or more features detected in the image and information that indicates locations of the one or more features within the image and transmit the feature information to the associated server for server-assisted localization and mapping. The mobile device is further adapted to, if any of the one or more criteria are satisfied, compress the image at the desired bitrate to provide a compressed image and transmit the compressed image to the associated server for server-assisted localization and mapping.

In one embodiment, a non-transitory computer-readable medium stores instructions executable by processing circuitry of a mobile device whereby mobile device is operable to obtain an image of an environment in which the mobile device is located from an associated camera, determine a desired bitrate for compression of the image based on one or more network conditions of a wireless network over which the mobile device is to transmit the image to an associated server for server-assisted localization and mapping, and determine) whether one or more criteria for transmission of the image at the desired bit are satisfied, the one or more criteria comprising a criterion that the image is to be transmitted at the desired bitrate if the desired bitrate is greater than a predefined or configured threshold bitrate for server-assisted localization and mapping. By execution of the instructions by the processing circuitry, the mobile device is further operable to, if the one or more criteria are not satisfied, perform a feature extraction procedure that detects one or more features in the image and provides feature information comprising information that describes the one or more features detected in the image and information that indicates locations of the one or more features within the image and transmit the feature information to the associated server for server-assisted localization and mapping. By execution of the instructions by the processing circuitry, the mobile device is further operable to, if any of the one or more criteria are satisfied, compress the image at the desired bitrate to provide a compressed image and transmit the compressed image to the associated server for server-assisted localization and mapping.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a plot that illustrates position, or localization, error for different compression levels for a particular server-assisted Simultaneous Localization and Mapping (SLAM) procedure;

FIG. 2 illustrates a server-assisted SLAM procedure in which a mobile device performs joint bitrate adaptation and feature extraction in accordance with one embodiment of the present disclosure;

FIG. 3 illustrates one example of a system that implements the server-assisted SLAM procedure of FIG. 2 in accordance with one embodiment of the present disclosure;

FIGS. 4, 5, and 6 are schematic block diagrams of example embodiments of an edge computing node according to the present disclosure; and

FIG. 7 is a schematic block diagram of an example embodiment of a mobile device according to the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Mobile Device: A mobile device is any type of wireless device that has access to (i.e., is served by) a wireless network (e.g., a cellular network). Some examples of a mobile device include, but are not limited to: a User Equipment device (UE) in a Third Generation Partnership Project (3GPP) network, a Machine Type Communication (MTC) device, and an Internet of Things (IoT) device. Such devices may be, or may be integrated into, another device, which may be another type of mobile device, such as, e.g., a mobile phone, smart phone, vehicle, virtual reality (VR) glasses, augmented reality (AR) glasses, robotic device, or the like, or integrated into any type of device for which localization is desired. The mobile device may be enabled to communicate voice and/or data via a wireless connection

It is to be appreciated that in the present disclosure, while reference is made to capturing, encoding, compressing, and/or transmitting “images”, these images can be frames of a video stream that are encoded and compressed via a video codec such as AVC/H.264, HEVC/H.265, or VVC/H.266. The video stream comprises the images at a certain rate or frames per second, and with a defined bitrate that is controlled by the video codec. Alternatively, the images can be individual images that are not part of a video stream, but are individually encoded and/or compressed to a predefined size, where the bitrate of the encoded and/or compressed images corresponds to a function of the size of the images and the rate at which the images are transmitted.

Localization and mapping, which is also known as Simultaneous Localization and Mapping (SLAM), refers to a computer-implemented procedure for constructing or updating a map an unknown environment while simultaneously keeping track of a mobile device's location within the unknown environment. Existing SLAM procedures are oftentimes implemented at the mobile device and are very energy demanding. As such, there is a need for systems and methods that reduce the energy demands of a SLAM procedure on the mobile device.

One way to reduce the energy demands of a SLAM procedure on a mobile device is to offload the SLAM procedure or at least some aspects of the SLAM procedure to an edge computing node or the “cloud”. Such offloading has been shown to greatly increase the battery lifetime of the mobile device even when considering the cost of streaming raw sensor data (e.g., raw images) to the edge computing node or the cloud in real-time. However, such streaming imposes a heavy demand on the wireless network. Therefore, systems and methods are disclosed herein for applying compression of the raw sensor data at the mobile device in order to reduce the demand on the wireless network. However, such compression may negatively impact the performance of the SLAM procedure. Thus, the systems and methods disclosed herein enable compression of raw sensor data (e.g., the raw images) at the mobile device prior to transmission over the wireless network in a manner that achieves at least a predefined or configured minimum acceptable performance for the SLAM procedure.

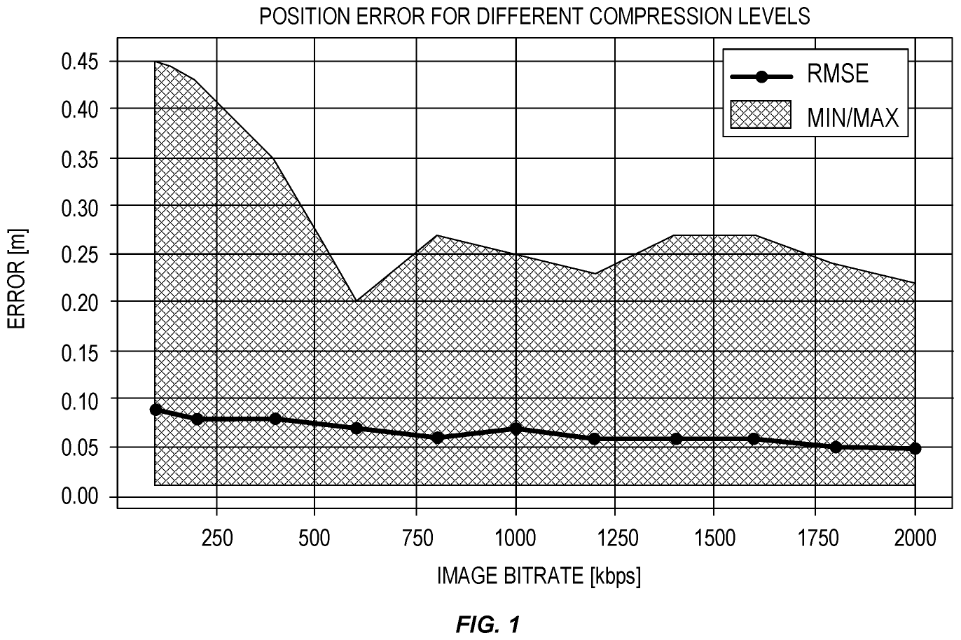

When evaluating the performance of the SLAM procedure as a function of the level of compression (i.e., the bitrate used for compression), the inventors found that one could find a minimum bitrate for which acceptable performance of the SLAM procedure was achieved. If the bitrate is lower than such value, performance SLAM procedure becomes significantly worse (e.g., ~5 centimeters (cm) to nearly 10 cm localization, or position, error for the evaluated scenario—see plot in FIG. 1). As described below, this minimum bitrate for which acceptable performance of the SLAM procedure is leveraged by the systems and methods disclosed herein to enable server-assisted SLAM using compressed image data in a manner that maintains the desired minimum acceptable performance of the SLAM procedure.

Visual SLAM procedures operate and create maps based on image features which can be extracted from images using state-of-the-art feature detectors and descriptors such as the Scale Invariant Feature Transform (SIFT) and Oriented Features from Accelerated Segment Test (FAST) and Rotated Binary Robust Independent Elementary Features (BRIEF) (ORB) feature detectors. SIFT and ORB provide lightweight descriptors of features detected in an image and can greatly reduce data requirements over full image transmission and storage.

State-of-the-art SLAM procedures that perform offline optimizations in order to improve the accuracy of the obtained map require full images (also called keyframes), where further feature extraction and pose (i.e., camera position and orientation) estimation given such features is performed. Even though a typical SLAM map is sparse, lightweight, and only used for localization purposes, applications such as robotics and Extended Reality (XR) require a denser map representation, which is typically performed by 3-Dimensional (3D) reconstruction of the keyframes which are part of the sparse SLAM map. Determining which images are keyframes in a sequence of images is a heuristic procedure where each SLAM algorithm defines its own, which can be based on a time period (e.g. every Nth frame or image is a keyframe), or if the device has travelled more than a predefined or configured distance (e.g., X meters), or when the overlap between the current image and the last identified keyframe is lower than a predefined or configured amount of overlap (e.g., Y %).

When performing server-assisted SLAM, the volumes of data to be transmitted over the network are very large. This brings the desire to compress this data. Further, bitrate adaptation procedures which determine the desired bitrate for an image stream given the available network bandwidth are known. However, such bitrate adaptation procedures may request a bitrate which degrades the performance of the server-assisted SLAM (e.g., degrades the localization performance) beyond acceptable values.

Systems and methods are disclosed herein for enabling server-assisted SLAM using compressed image data while maintaining at least a minimum acceptable performance for the SLAM procedure. In one embodiment, when the desired bitrate for image compression as determined by a bitrate adaptation procedure is below a predefined or configured minimum bitrate threshold that corresponds to a minimum acceptable SLAM performance, rather than transmitting a compressed image, the mobile device pre-processes the image to detect one or more image features from the image (e.g., one or more features to be used for the server-assisted SLAM) and provide information that describes the one or more detected image features and then transmits this information to the server. Conversely, when the desired bitrate for image compression as determined by the bitrate adaptation procedure is above the predefined or configured minimum bitrate threshold, the mobile device compresses the image at the desired bitrate and transmits the compressed image to the server. In this way, the desired bitrate is achieved while the SLAM performance is not compromised.

It should be noted that while the embodiments described herein refer to bitrate, any parameter related to an amount of compression or compression level can alternatively be used.

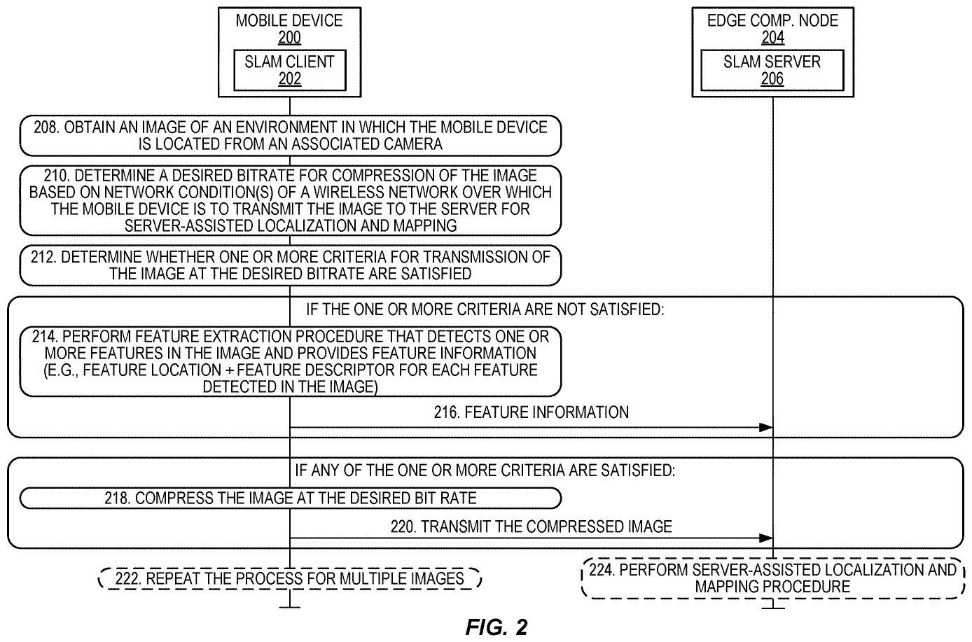

In this regard, FIG. 2 illustrates a server-assisted SLAM procedure using compressed image data in which joint bitrate adaptation and feature extraction is provided such that the performance of the server-assisted SLAM procedure remains at least at an acceptable performance level, in accordance with one embodiment of the present disclosure. As illustrated, the procedure involves a mobile device 200, which includes a SLAM client 202, and an edge computing node 204, which includes a SLAM server 206. The mobile device 200 is a wireless device that is enabled to transmit and receive data via an associated wireless network (e.g., a 3GPP cellular communications system), and the edge computing node 204 is a computing node, which may be a physical or virtualized computing node. While not illustrated in FIG. 2, the mobile device 200 and the edge computing node 204 (e.g., via a wired or wireless connection) communicate via a wireless network such as, e.g., a 3GPP 5G System (5GS) or Evolved Packet System (EPS) or any similar wireless communication system. In one embodiment, the mobile device 200 is a UE of a 3GPP 5GS, EPS, or similar wireless communication system.

As illustrated, the mobile device 200 (e.g., the SLAM client 202) obtains an image of an environment in which the mobile device 200 is located from an associated camera (step 208). The associated camera may be part of (i.e., integrated into) the mobile device 200 or separate from the mobile device 200. If separate, the camera is communicatively coupled to the mobile device 200 via a wireless or wireless interface (e.g., Bluetooth® interface or WiFi® interface). Note that, in one embodiment, images are obtained at a desired image capture rate for the server-assisted SLAM procedure (e.g., at a rate of 20 or 30 images per second). Thus, the procedure of FIG. 2 may be repeated for each image in this stream of captured images.

The mobile device 200 (e.g., the SLAM client 202) determines a desired bitrate for compression of the image based on one or network conditions of the wireless network over which the mobile device 200 is to transmit the image to the SLAM server 206 at the edge computing node 204 (step 210). As used herein, the “desired bitrate” is a bitrate for transmission over the wireless network determined by a bitrate adaptation procedure or function. Note that any suitable bitrate adaptation procedure may be used to determine the desired bitrate for transmission over the wireless network. In general, the bitrate adaptation procedure uses one or more network metrics (e.g., available bandwidth) to select a desired bitrate (e.g., from a predefined range of available bitrates). One non-limiting example of a bitrate adaptation procedure that can be used is the Self-Clocked Rate Adaptation for Multimedia procedure, which is sometimes referred to as “SCReAM”. In one embodiment, the one or more network conditions considered include available bandwidth in the wireless network. Note that the bitrate adaptation procedure may be performed by the SLAM client 202 or, e.g., a separate bitrate adaptation function of the mobile device 200.

The SLAM client 202 at the mobile device 200 determines whether one or more criteria for transmission of the image at the desired bitrate are satisfied (step 212). The one or more criteria include a criterion that the image is to be transmitted at the desired bitrate if the desired bitrate is greater than a predefined or configured threshold bitrate for server-assisted SLAM. This threshold bitrate is a bitrate that corresponds to a minimum acceptable performance level for the server-assisted SLAM procedure. In one embodiment, the threshold bitrate is predefined and is determined in advance via, e.g., simulations or experiments with real data captured by the mobile device in one or more real locations. As an example, for a particular SLAM procedure evaluated by the inventors, the inventors empirically found a minimum acceptable bitrate for which there was minimum degradation of that SLAM procedure in terms of localization performance (600 kilobits per second (kbps) bitrate for a 2 cm increased localization error—see FIG. 1). This type of experimentation to determine the bitrate threshold for an environment can be performed by applying different bitrates and executing the localization process on data collected by one or more devices in the given environment.

In one embodiment, the one or more criteria additionally or alternatively include a criterion that the image is to be transmitted at the desired bitrate if the image is a keyframe for the server-assisted SLAM procedure, even if the desired bitrate is less than the bitrate threshold. Determining which images are keyframes in a sequence of images is a heuristic procedure where each SLAM algorithm defines its own. In one embodiment, keyframes are based on a time period (e.g., every Nth image is a keyframe). In another embodiment, keyframes are based on distance travelled by the mobile device 200 since the last (i.e., immediately preceding in time) keyframe (e.g., if the mobile device 200 has move more than a predefined or configured distance (e.g., X meters) since the last keyframe, then the image is a keyframe). In another embodiment, keyframes are based on the amount of overlap with the last (i.e., immediately preceding in time) keyframe (e.g., if overlap between the image overlaps and the last keyframe is less than a predefined or configured amount of overlay (e.g., less than a Y % overlap), the image is a keyframe).

If the one or more criteria are not satisfied (e.g., if the desired bitrate is less than the bitrate threshold for acceptable SLAM performance and, optionally in some embodiments, if the image is not a keyframe), the SLAM client 202 performs a feature extraction procedure that detects one or more features in the image (e.g., one or more features to be used by the server-assisted SLAM procedure) and provides feature information (step 214). This feature information is information about the features detected in the image such as, e.g., information (e.g., feature descriptors) that describes the one or more features detected in the image and information that indicates locations of the one or more detected features within the image (e.g., as pixel locations within the image). The SLAM client 202 transmits the feature information, rather than the image or a compressed version thereof, to the SLAM server 206 (step 216). Features are parts or patterns of an object in an image that are of interest for a particular purpose(s), which for the present disclosure is SLAM. For example, features may include edges of objects, lines, a curve, points, or the like. As a specific example, consider a square object within an image. The square as four corners and four edges, all of which may be detected as features of the object within the image.

In one embodiment, the feature information includes feature descriptors that describe the one or more features detected in the image, where these feature descriptors use the same format as used by the SLAM server 206 for the server-assisted SLAM procedure. For example, in one embodiment, the feature descriptors are Binary Robust Independent Elementary Features (BRIEF) descriptors of the one or more detected features. The feature extraction procedure may be, for example, Features from Accelerated Segment Test (FAST), Oriented FAST and Rotated BRIEF (ORB), Scale-Invariant Feature Transform (SIFT), or the like. However, these feature extraction procedures are only examples. Any feature extraction procedure may be used. As an example, with ORB features used in ORB SLAM, a total of 500 features is detected per image, with a descriptor size of 32 bytes. This would amount to ~15 Kilobytes (KB) per image, which at 30 frames per second (fps), would require a total bandwidth of 450 kbps. The transmission of the feature information will provide a lower bandwidth utilization than performing a complete image compression, while SLAM algorithms can operate directly with features instead of full images.

Note that performing feature extraction and transmitting the resulting feature information for all images may not be desirable. Firstly, performing feature extraction for all images increases computational complexity and thus power consumption at the mobile device 200. Further, a typical SLAM map is sparse, lightweight, and only used for localization purposes, while applications such as robotics and XR require a denser map representation, which is typically performed by “3D reconstruction” algorithms on the “keyframes” which are part of the sparse SLAM map. The same rationale can be applied if semantic understanding of a scene is also required to be performed in conjunction with SLAM, which also operates on a full image. Thus, in certain cases it is desirable for the image itself, rather than the feature information, to be transmitted to the SLAM server 206 when possible.

If any of the one or more criteria are satisfied (e.g., if the desired bitrate is greater than the bitrate threshold for acceptable SLAM performance or, optionally in some embodiments, if the image is a keyframe), the SLAM client 202 compresses the image at the desired bitrate to provide a compressed image (step 218) and transmits the compressed image to the SLAM server 206 (step 220). Any suitable compression scheme and transmission protocol may be used. Some examples are H264 and Gstreamer.

The process of steps 208-220 may be repeated for multiple images (e.g., for a stream of images captured at a desired image capture rate for the server-assisted SLAM procedure) (step 222). At the edge computing node 204, the SLAM server 206 receive the feature descriptors in step 216 or the image in step 220 and, based on this received information, performs SLAM (step 224).

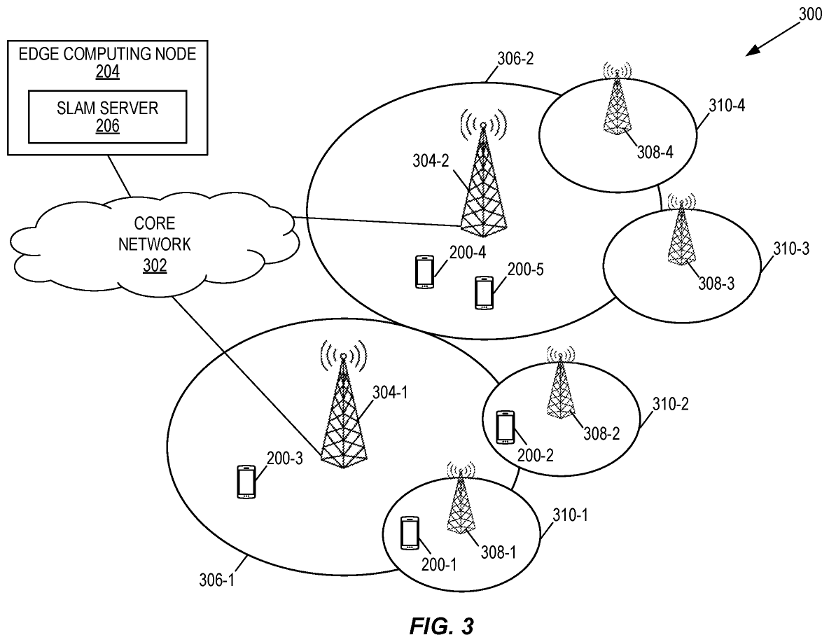

FIG. 3 illustrates one example of a system 300 in which embodiments of the present disclosure may be implemented. In the embodiments described herein, the system 300 includes a cellular communications system (e.g., a 5G system (5GS) or Evolved Packet System (EPS)) including a RAN (e.g., a Next Generation RAN (NG-RAN) in the case of a 5GS or an Evolved Universal Terrestrial RAN (E-UTRAN) in the case of an EPS) and a core network 302 (e.g., a 5G Core (5GC) in the case of a 5GS or an Evolved Packet Core (EPC) in the case of an EPS). In this example, the RAN includes base stations 304-1 and 304-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 306-1 and 306-2. The base stations 304-1 and 304-2 are generally referred to herein collectively as base stations 304 and individually as base station 304. Likewise, the (macro) cells 306-1 and 306-2 are generally referred to herein collectively as (macro) cells 306 and individually as (macro) cell 306. The RAN may also include a number of low power nodes 308-1 through 308-4 controlling corresponding small cells 310-1 through 310-4. The low power nodes 308-1 through 308-4 can be small base stations (such as pico or femto base stations) or RRHs, or the like. Notably, while not illustrated, one or more of the small cells 310-1 through 310-4 may alternatively be provided by the base stations 304. The low power nodes 308-1 through 308-4 are generally referred to herein collectively as low power nodes 308 and individually as low power node 308. Likewise, the small cells 310-1 through 310-4 are generally referred to herein collectively as small cells 310 and individually as small cell 310. The base stations 304 (and optionally the low power nodes 308) are connected to the core network 310. The base stations 304 and the low power nodes 308 provide service to mobile devices 200-1 through 200-5, each of which is an example of the mobile device 200 of FIG. 2.

The system 300 also includes the edge computing node 204 including the SLAM server 206 of FIG. 2, where the edge computing node 204 and thus the SLAM server 206 are connected to the core network 302 and are able to communicate with the mobile devices 200-1 through 200-5 via the cellular communications system. The mobile device 200 (including the SLAM client 202), the edge computing node 204, and the SLAM server 206 operate as described above with respect to FIG. 2.

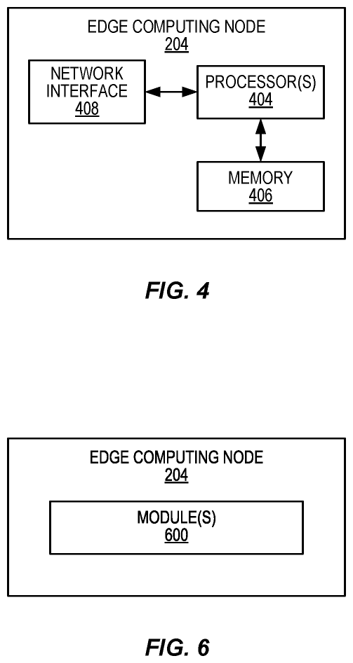

FIG. 4 is a schematic block diagram of an example embodiment of the edge computing node 204. As illustrated, the edge computing node 204 includes one or more processors 404 (e.g., Central Processing Units (CPUs), Application Specific Integrated Circuits (ASICs), Field Programmable Gate Arrays (FPGAs), and/or the like), memory 406, and a network interface 408. The one or more processors 404 are also referred to herein as processing circuitry. The one or more processors 404 operate to provide one or more functions of the edge computing node 204, and in particular the SLAM server 206, as described herein. In some embodiments, the function(s) are implemented in software that is stored, e.g., in the memory 406 and executed by the one or more processors 404.

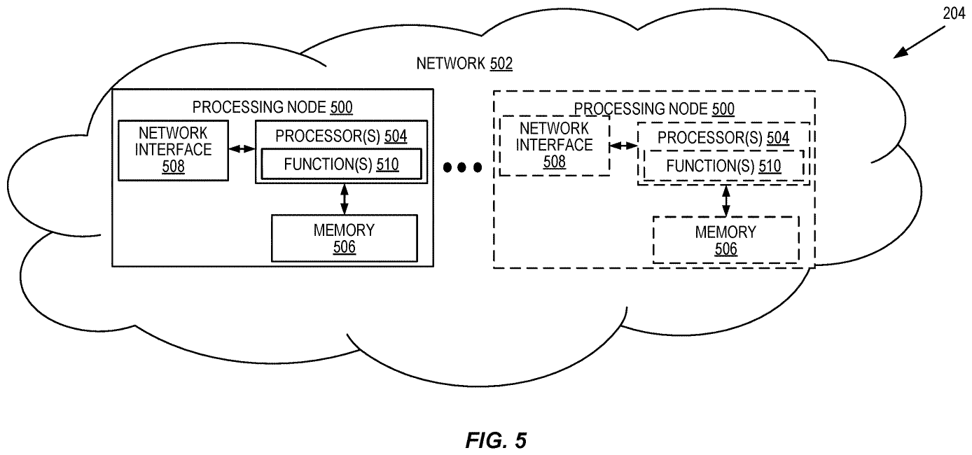

FIG. 5 is a schematic block diagram that illustrates a virtualized embodiment of the edge computing node 204 according to some embodiments of the present disclosure. Optional features are represented by dashed boxes. As used herein, a “virtualized” edge computing node is an implementation of the edge computing node 204 in which at least a portion of the functionality of the edge computing node 204 is implemented as a virtual component(s) (e.g., via a virtual machine(s) executing on a physical processing node(s) in a network(s)). As illustrated, in this example, the edge computing node 204 includes one or more processing nodes 500 coupled to or included as part of a network(s) 502. Each processing node 500 includes one or more processors 504 (e.g., CPUs, ASICs, FPGAs, and/or the like), memory 506, and a network interface 508. In this example, functions 510 of the edge computing node 204, and in particular the SLAM server 206, described herein are implemented at the one or more processing nodes 500 or distributed across the two or more processing nodes 500 in any desired manner. In some particular embodiments, some or all of the functions 510 of the edge computing node 204 described herein are implemented as virtual components executed by one or more virtual machines implemented in a virtual environment(s) hosted by the processing node(s) 500.

In some embodiments, a computer program including instructions which, when executed by at least one processor, causes the at least one processor to carry out the functionality of the edge computing node 204, or the SLAM server 206, or a node (e.g., a processing node 500) implementing one or more of the functions 510 of the edge computing node 204 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 6 is a schematic block diagram of the edge computing node 204 according to some other embodiments of the present disclosure. The edge computing node 204 includes one or more modules 600, each of which is implemented in software. The module(s) 600 provide the functionality of the edge computing node 204, and more specifically the SLAM server 206, described herein. This discussion is equally applicable to the processing node 500 of FIG. 5 where the modules 600 may be implemented at one of the processing nodes 500 or distributed across multiple processing nodes 500.

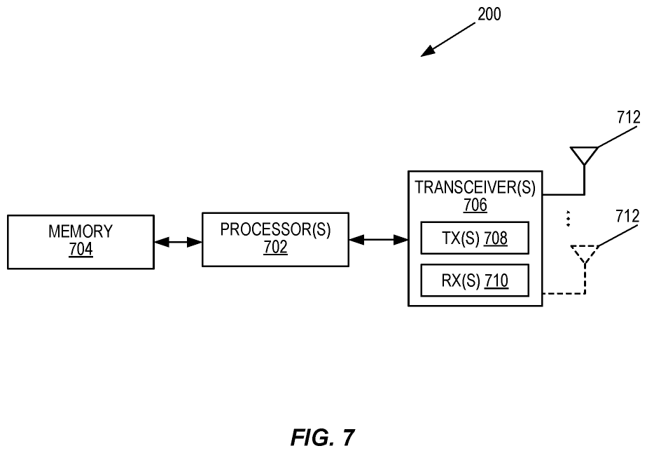

FIG. 7 is a schematic block diagram of an example embodiment of the mobile device 200. As illustrated, the mobile device 200 includes one or more processors 702 (e.g., CPUs, ASICs, FPGAs, and/or the like), memory 704, and one or more transceivers 706 each including one or more transmitters 708 and one or more receivers 710 coupled to one or more antennas 712. The transceiver(s) 706 includes radio-front end circuitry connected to the antenna(s) 712 that is configured to condition signals communicated between the antenna(s) 712 and the processor(s) 702, as will be appreciated by on of ordinary skill in the art. The processors 702 and 705 are also referred to herein as processing circuitry. The transceivers 707 are also referred to herein as radio circuitry. In some embodiments, the functionality of the mobile device 200, and in particular that of the SLAM client 202, described above may be fully or partially implemented in software that is, e.g., stored in the memory 704 and executed by the processor(s) 702. Note that the mobile device 200 may include additional components not illustrated in FIG. 7 such as, e.g., one or more user interface components (e.g., an input/output interface including a display, buttons, a touch screen, a microphone, a speaker(s), and/or the like and/or any other components for allowing input of information into the mobile device 200 and/or allowing output of information from the mobile device 200), a power supply (e.g., a battery and associated power circuitry), etc.

In some embodiments, a computer program including instructions which, when executed by at least one processor, causes the at least one processor to carry out the functionality of the mobile device 200, or the SLAM client 202, according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a mobile device for server-assisted localization and mapping, the method comprising:
obtaining an image of an environment in which the mobile device is located from an associated camera;
determining a desired bitrate for compression of the image based on one or more network conditions of a wireless network over which the mobile device is to transmit the image to an associated server for server-assisted localization and mapping;
determining whether one or more criteria for transmission of the image at the desired bitrate are satisfied, the one or more criteria comprising a criterion that the image is to be transmitted at the desired bitrate if the desired bitrate is greater than a threshold bitrate for minimum acceptable performance of server-assisted localization and mapping;
if the one or more criteria are not satisfied:
performing a feature extraction procedure that detects one or more features in the image and provides feature information, the feature information comprising information that describes the one or more features detected in the image and information that indicates locations of the one or more features within the image; and
transmitting the feature information to the associated server for server-assisted localization and mapping; and
if any of the one or more criteria are satisfied:
compressing the image at the desired bitrate to provide a compressed image; and
transmitting the compressed image to the associated server for server-assisted localization and mapping.

2. The method of claim 1 wherein the one or more criteria for transmission of the image at the desired bitrate comprises a criterion that the image is to be transmitted at the desired bitrate if the image is a keyframe, even if the desired bitrate is less than the predefined or configured threshold bitrate for server-assisted localization and mapping.

3. The method of claim 2 wherein keyframes for the server-assisted localization and mapping are defined as every Nth image where N is an integer value that is greater than 1, defined as images obtained after the mobile device has moved more than a predefined or configured distance, or defined an image for which an overlap between the image and a last keyframe is less than a predefined or configured amount of overlap.

4. The method of claim 1 wherein determining the desired bitrate for compression of the image based on the one or more network conditions of the wireless network is in accordance with a bitrate adaptation scheme that dynamically adapts bitrate according to available network bandwidth.

5. The method of claim 1 wherein determining whether the one or more criteria for transmission of the image at the desired bitrate are satisfied, comprises determining that the one or more criteria are not satisfied, and the method further comprises, responsive to determining that the one or more criteria are not satisfied:
performing a feature extraction procedure that detects one or more features in the image and provides feature information, the feature information comprising information that describes the one or more features detected in the image and information that indicates locations of the one or more features within the image; and
transmitting the feature information to the associated server for server-assisted localization and mapping.

6. The method of claim 1 wherein determining whether the one or more criteria for transmission of the image at the desired bitrate are satisfied, comprises determining that at least one of the one or more criteria is satisfied, and the method further comprises, responsive to determining that the at least one of the one or more criteria is satisfied:
compressing the image at the desired bitrate to provide a compressed image; and
transmitting the compressed image to the associated server for server-assisted localization and mapping.

7. The method of claim 1 wherein the method is repeated for a plurality of images.

8. A mobile device for server-assisted localization and mapping, the mobile device adapted to:
obtain an image of an environment in which the mobile device is located from an associated camera;
determine a desired bitrate for compression of the image based on one or more network conditions of a wireless network over which the mobile device is to transmit the image to an associated server for server-assisted localization and mapping;
determine whether one or more criteria for transmission of the image at the desired bitrate are satisfied, the one or more criteria comprising a criterion that the image is to be transmitted at the desired bitrate if the desired bitrate is greater than a predefined or configured threshold bitrate for server-assisted localization and mapping;
if the one or more criteria are not satisfied:
perform a feature extraction procedure that detects one or more features in the image and provides feature information, the feature information comprising information that describes the one or more features detected in the image and information that indicates locations of the one or more features within the image; and
transmit the feature information to the associated server for server-assisted localization and mapping; and
if any of the one or more criteria are satisfied:
compress the image at the desired bitrate to provide a compressed image; and
transmit the compressed image to the associated server for server-assisted localization and mapping.

9. (canceled)

10. A mobile device for server-assisted localization and mapping, the mobile device comprising:
one or more transmitters and one or more receivers; and
processing circuitry associated with the one or more transmitters and the one or more receivers, the processing circuitry configured to cause the mobile device to:
obtain an image of an environment in which the mobile device is located from an associated camera;
determine a desired bitrate for compression of the image based on one or more network conditions of a wireless network over which the mobile device is to transmit the image to an associated server for server-assisted localization and mapping;
determine whether one or more criteria for transmission of the image at the desired bitrate are satisfied, the one or more criteria comprising a criterion that the image is to be transmitted at the desired bitrate if the desired bitrate is greater than a predefined or configured threshold bitrate for server-assisted localization and mapping;
if the one or more criteria are not satisfied:
perform a feature extraction procedure that detects one or more features in the image and provides feature information, the feature information comprising information that describes the one or more features detected in the image and information that indicates locations of the one or more features within the image; and
transmit the feature information to the associated server for server-assisted localization and mapping; and
if any of the one or more criteria are satisfied:
compress the image at the desired bitrate to provide a compressed image; and
transmit the compressed image to the associated server for server-assisted localization and mapping.

11. The mobile device of claim 10 wherein the one or more criteria for transmission of the image at the desired bitrate comprises a criterion that the image is to be transmitted at the desired bitrate if the image is a keyframe, even if the desired bitrate is less than the predefined or configured threshold bitrate for server-assisted localization and mapping.

12. The mobile device of claim 11 wherein keyframes for the server-assisted localization and mapping are defined as every Nth image where N is an integer value that is greater than 1, defined as images obtained after the mobile device has moved more than a predefined or configured distance, or defined an images for which an overlap between the image and a last keyframe is less than a predefined or configured amount of overlap.

13. The mobile device of claim 10 wherein the processing circuitry is further configured to cause the mobile device to determine the desired bitrate for compression of the image based on the one or more network conditions of the wireless network in accordance with a bitrate adaptation scheme that dynamically adapts bitrate according to available network bandwidth.

14. The mobile device of claim 10 wherein the one or more criteria are not satisfied, and the processing circuitry is further configured to cause the mobile device to, responsive to determining that the one or more criteria are not satisfied:
perform a feature extraction procedure that detects one or more features in the image and provides feature information, the feature information comprising information that describes the one or more features detected in the image and information that indicates locations of the one or more features within the image; and
transmit the feature information to the associated server for server-assisted localization and mapping.

15. The mobile device of claim 10 wherein at least one of the one or more criteria is satisfied, and the processing circuitry is further configured to cause the mobile device to, responsive to determining that the at least one of the one or more criteria is satisfied:
compress the image at the desired bitrate to provide a compressed image; and
transmit the compressed image to the associated server for server-assisted localization and mapping.

16. The mobile device of claim 10 wherein the processing circuitry is further configured to repeat the functions of obtaining the image, determining the desired bitrate, determining whether the one or more criteria are satisfied, performing the feature extraction procedure and transmitting the information that describes the one or more features detected in the image if the one or more criteria are not satisfied, and compressing the image at the desired bitrate and transmitting the compressed image if any of the one or more criteria are satisfied, for a plurality of images.

17. A non-transitory computer-readable medium storing instructions executable by processing circuitry of a mobile device whereby mobile device is operable to:
obtain an image of an environment in which the mobile device is located from an associated camera;
determine a desired bitrate for compression of the image based on one or more network conditions of a wireless network over which the mobile device is to transmit the image to an associated server for server-assisted localization and mapping;
determine whether one or more criteria for transmission of the image at the desired bit are satisfied, the one or more criteria comprising a criterion that the image is to be transmitted at the desired bitrate if the desired bitrate is greater than a predefined or configured threshold bitrate for server-assisted localization and mapping;
if the one or more criteria are not satisfied:
perform a feature extraction procedure that detects one or more features in the image and provides feature information, the feature information comprising information that describes the one or more features detected in the image and information that indicates locations of the one or more features within the image; and
transmit the feature information to the associated server for server-assisted localization and mapping; and
if any of the one or more criteria are satisfied:
compress the image at the desired bitrate to provide a compressed image; and
transmit the compressed image to the associated server for server-assisted localization and mapping.

18. The non-transitory computer-readable medium of claim 17, wherein the one or more criteria for transmission of the image at the desired bitrate comprises a criterion that the image is to be transmitted at the desired bitrate if the image is a keyframe, even if the desired bitrate is less than the predefined or configured threshold bitrate for server-assisted localization and mapping.

19. The non-transitory computer-readable medium of claim 18, wherein keyframes for the server-assisted localization and mapping are defined as every Nth image where N is an integer value that is greater than 1, defined as images obtained after the mobile device has moved more than a predefined or configured distance, or defined an image for which an overlap between the image and a last keyframe is less than a predefined or configured amount of overlap.

20. The non-transitory computer-readable medium of claim 17, wherein determining the desired bitrate for compression of the image based on the one or more network conditions of the wireless network is in accordance with a bitrate adaptation scheme that dynamically adapts bitrate according to available network bandwidth.

21. The non-transitory computer-readable medium of claim 17, wherein determining whether the one or more criteria for transmission of the image at the desired bitrate are satisfied, comprises determining that the one or more criteria are not satisfied, and the method further comprises, responsive to determining that the one or more criteria are not satisfied:
performing a feature extraction procedure that detects one or more features in the image and provides feature information, the feature information comprising information that describes the one or more features detected in the image and information that indicates locations of the one or more features within the image; and
transmitting the feature information to the associated server for server-assisted localization and mapping.
